(19) United States
(12) Patent Application Publication
(10) Pub. No.: US 2015/0139253 A1
(43) Pub. Date: May 21, 2015

(54) RECYCLED-CARRIER MODULATION

(71) Applicant: Phase Sensitive Innovations, Inc., Newark, DE (US)

(72) Inventors: Janusz Murakowski, Bear, DE (US); Garrett Schneider, New Castle, DE (US); Christopher A. Schuetz, Newark, DE (US); Dennis W. Prather, Newark, DE (US)

(73) Assignee: PHASE SENSITIVE INNOVATIONS, INC., Newark, DE (US)

(21) Appl. No.: 14/083,671

(22) Filed: Nov. 19, 2013

(51) Int. Cl. H04B 10/516

(52) U.S. Cl. CPC H04B 10/516
USPC 370/542

(57) ABSTRACT

An optical modulation apparatus for modulating an electromagnetic (e.g., radio frequency (RF)) signal onto an optical carrier signal may use carrier recycling to increase modulation efficiency. Such an arrangement may be implemented, e.g., using a Fabry-Perot topology and/or using a travelling-wave modulator.

### FIELD OF THE INVENTION

Embodiments of the invention may relate to modulation of optical carrier signals.

### BACKGROUND

Modulator efficiency, in addition to bandwidth, is an important parameter in characterizing a modular. In electro-optic modulators the efficiency is often expressed as V_{π}, which is the voltage amplitude required to effect a π-shift in phase of the light beam propagating through it. Alternatively, and equivalently, the modulator efficiency can be expressed as the proportionality constant that relates the amount of power in the sidebands of the modulated signal to the product of the radio frequency (RF) and the optical powers entering the modulator. For example, if a modulator efficiency is 1 W⁻¹, it means that with one watt of optical power entering the modulator, and one watt of RF power coming in, the power in the sideband at the modulator output is one watt. 0.5 W⁻¹ efficiency would mean that with the same inputs as above (1 W optical and 1 W RF in), only 0.5 W would be detected in the sideband at the modulator output.

Consequently, any approach that can improve on existing modulator efficiencies, particularly without compromising bandwidth, is a desirable result.

### BRIEF SUMMARY OF EMBODIMENTS OF THE INVENTION

Various embodiments of the present invention may address the issue of modulation efficiency in optical modulators. In particular, various embodiments of the invention may present an optical modulation using recycling of a carrier signal, which may improve modulation efficiency.

### BRIEF DESCRIPTION OF THE DRAWINGS

Various embodiments of the invention will now be described in conjunction with the accompanying drawings, in which:

FIG. 1 shows a background art example of a modulator;

FIG. 2 shows an example of a conceptual block diagram of a recycled-carrier modulator (RCM) according to the present disclosure;

FIG. 3 shows an example of an implementation of an RCM according to the present disclosure;

FIG. 4 shows a block diagram of a variation of an implementation of an RCM according to the present disclosure;

FIGS. 5A and 5B show block diagrams depicting further variations of the RCM according to the present disclosure;

FIG. 6 shows a block diagram of another example implementation of an RCM; and

FIG. 7 shows a block diagram of still another example implementation of an RCM.

### DETAILED DESCRIPTION

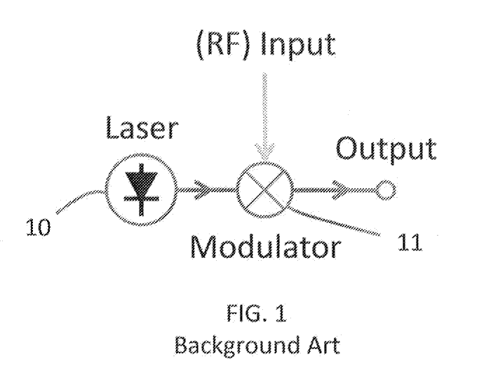

Various aspects of the present disclosure present new methods and devices for modulation of optical carrier signals. In a conventional modulator, as shown in FIG. 1, an optical signal (or, as used interchangeably in this disclosure, beam), typically, but not necessarily, from a laser 10, mar be input to a modulator 11. At the modulator 11, the signal may undergo a change dependent on the applied electrical (e.g., radio-frequency (RF)) signal. The change may be, for example, in the phase (in a phase modulator) or in the amplitude (in an amplitude modulator) of the optical beam; but other variations are possible, as well. In the frequency domain, the presence of modulation may be indicated in the form of sidebands flanking the pure tone of the optical carrier frequency.

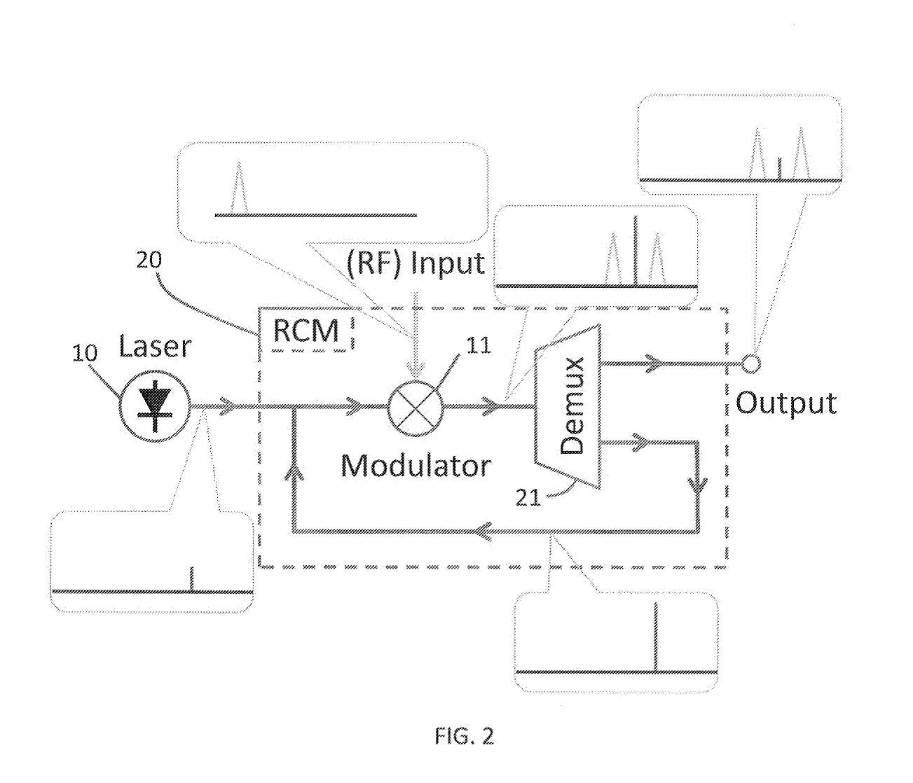

FIG. 2 shows a block diagram that demonstrates some concepts of this disclosure. According to this conceptual example, the output of the modulator 11 may be split into two paths: one carrying mostly the sidebands (suppressed carrier), and one with mostly the carrier present (sidebands filtered out). This splitting is schematically represented in FIG. 2 using a demultiplexer 21 but may be achieved using a variety of methods/apparatus. The signal of the latter path may then be combined with the input of the modulator 11. The combination of modulator 11 and demultiplexer 21, along with a feedback path, may thus form a recycled-carrier modulator (RCM) 20. FIG. 2 shows the spectral content of the signals that may occur, in the frequency domain, at various points in the apparatus, using callout balloons. As shown, the input optical power of the pure tone carrier to the modulator 11 may be increased as a result of this “recycling” of the optical carrier. The increase in the optical power entering the modulator 11 may, in turn, result in higher power in the sidebands at the modulator output, i.e., higher modulation efficiency.

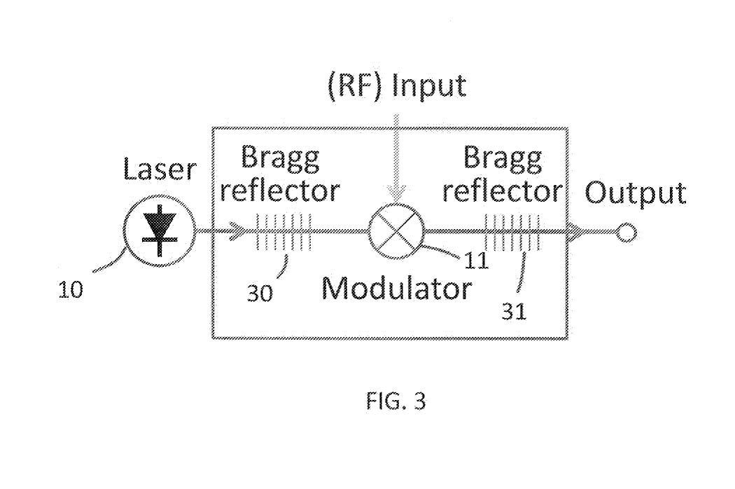

In one practical implementation, shown in FIG. 3, a conventional modulator 11 may be embedded in a Fabry-Perot resonator, where the mirrors may be frequency (wavelength) selective—i.e., the mirrors may reflect mostly or only the carrier wavelength and may let one or more of the sidebands pass through. Such frequency-selective mirrors can take the form of Bragg reflectors 30 and 31, which may be implemented, for example, as gratings patterned in the optical waveguide structure of the modulator 11, but which may be implemented in other ways, as well. In this implementation, the role of the demultiplexer 21 may be played by the Bragg reflectors 30 and 31, which may separate the carrier wavelength (reflect it) from the modulation-imposed sidebands (and may pass one or more of them through). The reflected carrier wave from Bragg reflector 31 may reflect off Bragg reflector 30 to route the energy of the reflected carrier wave into the modulator 11. It is noted that in this arrangement, the modulator 11 may be thought of as being positioned inside a resonant Fabry-Perot cavity defined by wavelength-selective mirrors 30, 31.

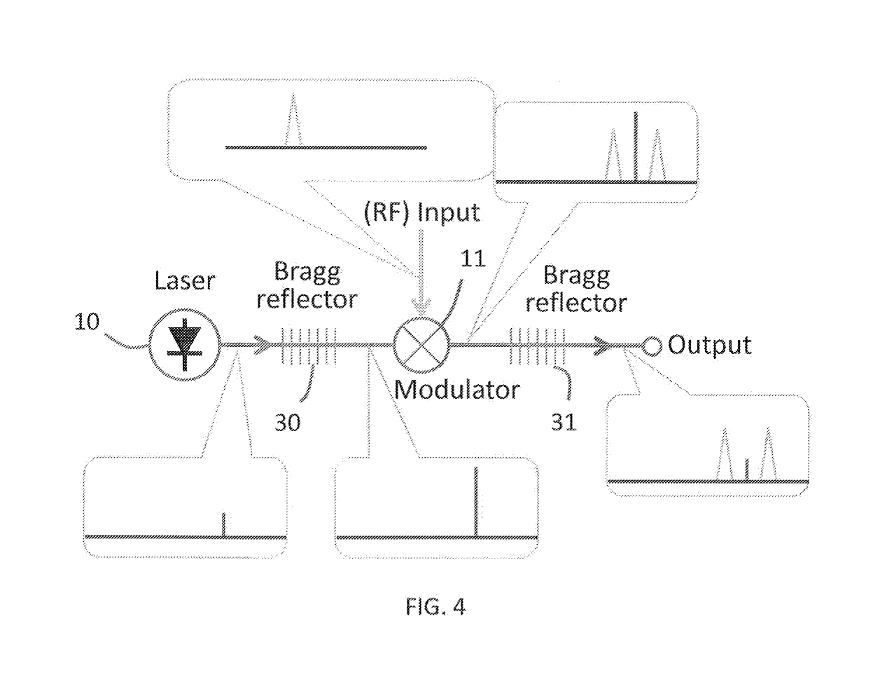

The implementation of FIG. 3 may take several forms, non-limiting examples of which are described below. For example, in FIG. 4, the mirrors may act as notch filters, and accordingly, a resonant cavity in which modulator 11 is positioned in FIG. 4 may be configured to provide field enhancement at the carrier wavelength (but not at the wavelengths of sidebands corresponding to the modulating signal). As a result, the modulating signal may significantly pass through the cavity only once, but the cavity may enhance the carrier signal such that the strength of the carrier signal fed to modulator 11 is increased in comparison with the arrangement of FIG. 1. As a result, at the output, the sidebands containing the modulating signal may, in turn, be stronger by a factor related to the cavity finesse, while the output carrier power may be approximately the same as the input carrier power to the modulation apparatus from laser 10.

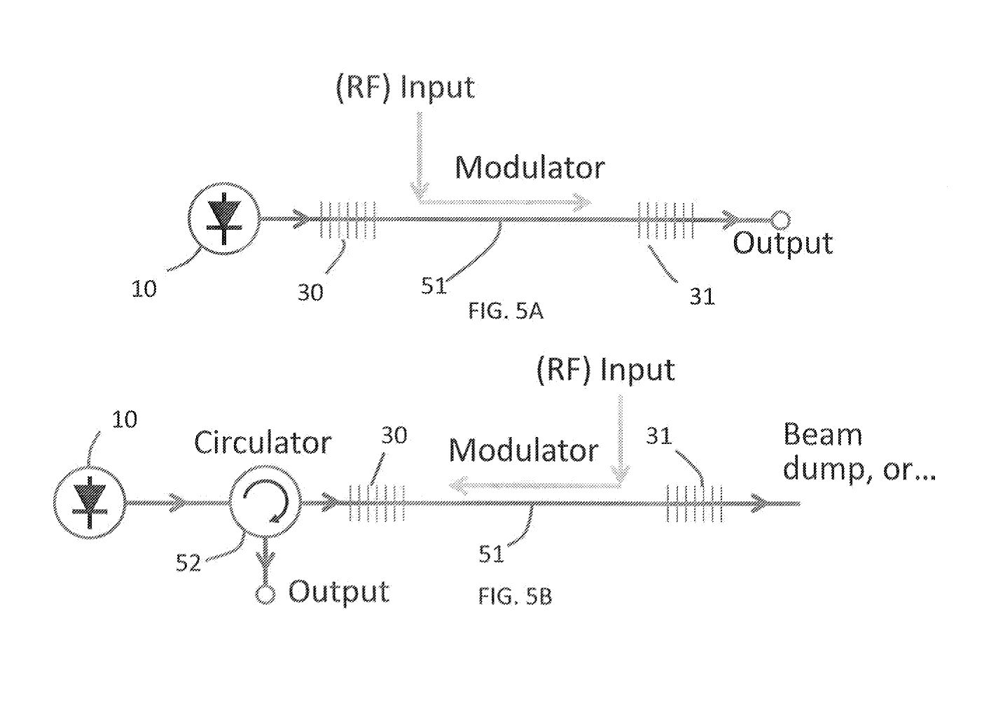

In a further variation on the above implementations, the modulator may be implemented in the for of is traveling-wave modulator 51, as shown in the implementations of FIGS. 5A and 5B. The use of a traveling-wave modulator 51 may, for example, make the modulation apparatus more versatile. For example, using a traveling-wave modulator 51, modulation may occur in a “forward direction,” away from laser 10, or in a “reverse direction,” toward the laser 10, e.g., as shown in the figures. As shown in FIG. 5B, a circulator 52 may be inserted to enable an output in the reverse direction. It is noted that, for a high-finesse cavity, the amount of optical power at the carrier wavelength traveling in the reverse direction may be nearly as high as the amount of optical power at the carrier wavelength traveling in the forward direction. As a result, the modulation efficiency of the arrangement of FIG. 5B may be nearly as high as that of the arrangement of FIG. 5A. However, the carrier power emerging from the output in FIG. 5B may be significantly lower than the carrier power emerging from the output of FIG. 5A.

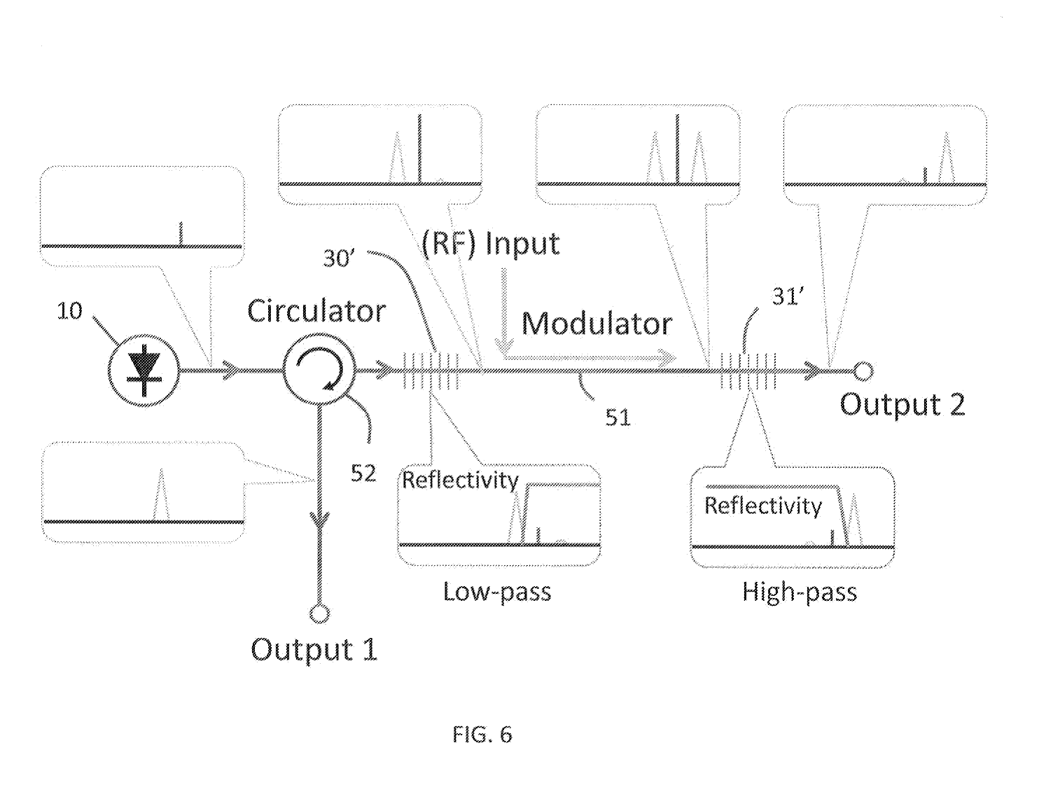

A possible variation of the apparatus may enable the apparatus to provide different types of single sideband modulation using the same apparatus, as shown in FIG. 6. As with FIG. 5B, the apparatus of FIG. 6 may include a circulator 52. The apparatus of FIG. 6 provides two outputs. Additionally, the Bragg reflectors 30′, 31′ are configured such that their reflectivities may act to provide low-pass and high-pass filtering, respectively, of the signals that are incident to them. As shown in FIG. 6, as an example, Bragg reflector 30′ may be configured to effect low-pass filtering, providing a relatively high degree of reflectivity at higher frequencies and a relatively low degree of reflectivity at lower frequencies, while Bragg reflector 31′ may be configured to effect high-pass filtering, with a relatively high degree of reflectivity at lower frequencies and a relatively low degree of and reflectivity at higher frequencies. As a result, in the forward direction, the output may provide a single sideband (or vestigial sideband) signal of a high-pass type, while in the reverse direction, the output may provide a single sideband (or vestigial sideband) signal of a low-pass type. Note that the invention is not thus limited, and the Bragg reflectors 30′ and 11′ may be of the opposite types, which may thus result in the opposite signals at the respective outputs. Furthermore, the RCM functionality may alternatively be achieved by a combination of a low (high)-pass filter and a notch filter, or other arrangements, as long as the optical carrier wavelength falls significantly within the reflectivity band of both filters and each generated sideband is significantly passed by at least one of the filters.

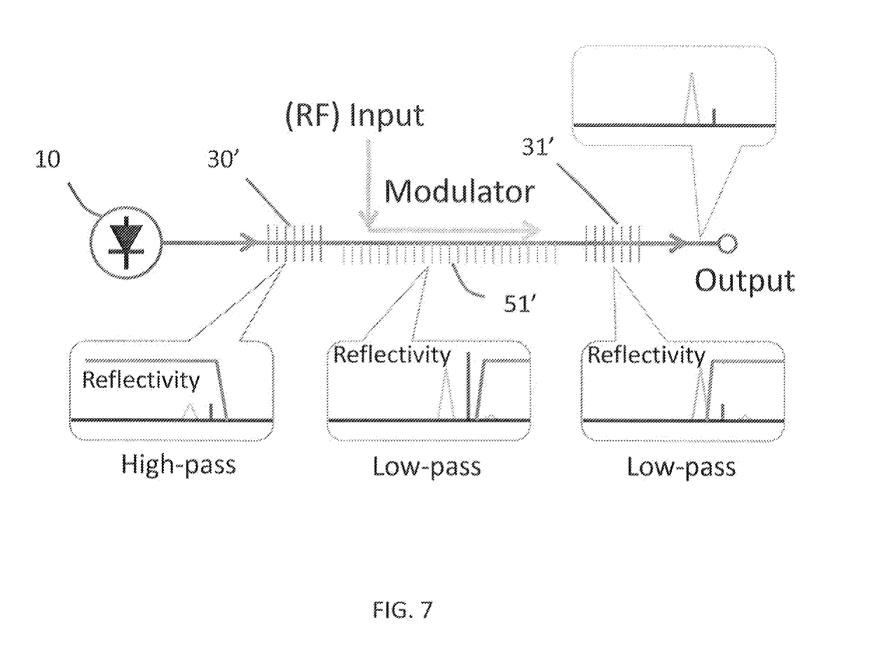

Another way of generating a single-sideband (or vestigial sideband) signal may be to incorporate sideband suppression within the modulator itself. As shown in the example of FIG. 7, modulator 51′ may be configured to provide, for example, low-pass selectivity (the selectivity is not limited to low-pass and may be, alternatively, high-pass, for example, in a high-pass implementation). Bragg reflectors 30′ and 11′ may, accordingly, be configured to provide a low-pass signal output in this non-limiting example (again, other configurations may be designed to provide other types of signals).

Various implementations of the recycled-carrier modulator according to the present disclosure may provide more optical carrier power circulating through the modulator proper than enters the apparatus, as a result of the recycling of the carrier. As a result, more power may appear in the sidebands than in conventional optical modulators, while using the same amount of modulating RF power. Consider a simple numerical example, based on FIGS. 2 and 3. Assume that the modulation efficiency of the modulator 11 of FIG. 2 is 1 W⁻¹. Assume also that the amount of optical power circulating in the loop of FIG. 2 is 10 times the amount of optical power entering the device from the laser 10. In the implementation of FIG. 3, this may be accomplished with mirrors 30, 31 having a combined reflectivity of 90% at the carrier wavelength (\sqrt{0.9}=0.95, for example, for each of the mirrors). Now, if the optical power emitted by the laser 10 is 10 mW, then the optical power going through the modulator 11 is 100 mW. As a result, 1 mW of input RF power may produce sidebands with 0.1 mW of power at the output. Therefore, the modulation efficiency of the device may be 10 mW⁻¹ (10 mW optical input and 1 mW RF input producing 0.1 mW sideband), which is ten time s as high as the modulation efficiency of the ‘bare’ modulator 11 of FIG. 1—in the absence of carrier recycling.

Thus, recycled carrier modulation may increase modulation efficiency. Another possible advantage of this solution over other modulator designs that utilize resonant phenomena is that implementations of the present design may not compromise the bandwidth of the modulator. Indeed, since the modulated signal need go only once through the modulation region, the bandwidth of the modulator 11 may be preserved. In contrast, in resonant designs that recycle both the carrier and the sidebands, e.g.; by using broadband mirrors in a Fabry-Perot resonator configuration, the bandwidth may be limited by the quality factor {tilde under (O)} of the structure (the increase of ring-down time may reduce the signal bandwidth that can be accommodated).

The present techniques may be embodied as a method in which recycled carrier modulation may be implemented by providing an optical carrier to a carrier recycling arrangement and modulating the optical carrier, including a recycled portion, with an RF modulating signal. The method may be similarly modified in accordance with the variations discussed above.

Various embodiments of the invention have now been discussed in detail; however, the invention should not be understood as being limited to these embodiments. It should also be appreciated that various modifications, adaptations, and alternative embodiments thereof may be made within the scope and spirit of the present invention.

What is claimed is:

1. An apparatus for modulating an optical carrier, the apparatus including:
a modulator configured to modulate a radio-frequency (RF) signal from an RF input of the modulator onto an optical carrier signal from an optical Input of the modulator to generate a modulated signal; and
demultiplexing arrangement configured to demultiplex at least a portion of the optical carrier signal from the modulated signal and to feedback the at least a portion of the optical carrier signal to the optical input of the modulator.

2. The apparatus of claim 1, wherein the demultiplexing arrangement comprises a frequency-selective optical reflector.

3. The apparatus of claim 2, wherein the frequency-selective optical reflector comprises a Bragg reflector.

4. The apparatus of claim 1, wherein the demultiplexing arrangement comprises at least two frequency-selective optical reflectors, and wherein at least a first one of the frequency-selective optical reflectors is configured to effect low-pass or high-pass filtering of a signal incident to the at least a first one of the frequency-selective optical reflectors, such that the optical carrier signal falls substantially within a reflectivity band of the at least a first one of the frequency-selective optical reflectors.

5. The apparatus or clam 4, wherein the apparatus includes at least one output configured to provide a low-pass modulated output signal or at least one output configured to provide a high-pass modulated output signal.

6. The apparatus of claim 2, wherein the modulator comprises a traveling-wave modulator.

7. The apparatus to claim 6, wherein the apparatus includes at least one output configured to provide a forward-direction modulated output signal or at least one output configured to provide a reverse-direction modulated output signal.

8. The apparatus of claim 6, wherein the traveling-wave modulator is configured to provide suppression of at least one sideband.

9. The apparatus of claim 8, wherein at least one of the frequency-selective optical reflectors is configured to pass at least one sideband of an incident signal that is not suppressed by the traveling-wave modulator.

10. The apparatus of claim 9, wherein the apparatus includes at least one output configured to provide a low-pass modulated output signal or at least one output configured to provide a high-pass modulated output signal.

11. A method of modulating a radio-frequency (RF) signal onto an optical carrier signal, the method including:
modulating an RF input signal onto an optical carrier signal to produce a modulated signal;
demultiplexing at least a portion of the optical carrier signal from the modulated signal to provide a recycled portion of the optical carrier signal; and
providing the recycled portion of the optical carrier signal in combination with the optical carrier signal as input to the modulating.

12. The method of claim 11, wherein the demultiplexing includes reflecting the modulated signal of a frequency-selective optical reflector to perform the demultiplexing and the providing.

13. The method of claim 11, further comprising obtaining a single-sideband output signal using at least two frequency-selective optical reflectors, wherein a first frequency-selective optical reflector is configured in a low-pass arrangement or a high-pass arrangement.

14. The method of claim 11, further comprising obtaining a single-sideband output signal using at least two frequency-selective optical reflectors, wherein is first frequency-selective optical reflector is configured in a low-pass arrangement or a high-pass arrangement and a second frequency-selective optical reflector is configured, respectively, in a high-pass arrangement or a low-pass arrangement.
